(19) United States
(12) Patent Application Publication
(10) Pub. No.: US 2010/0229416 A1
(43) Pub. Date: Sep. 16, 2010

(54) SUBSTRATE PROCESSING APPARATUS

(75) Inventors: Yukinori ABURATANI, Toyama-shi (JP); Seiyo NAKASHIMA, Toyama-shi (JP); Masakazu SHIMADA, Toyama-shi (JP)

Correspondence Address: BRUNDIDGE & STANGER, P.C., 2318 MILL ROAD, SUITE 1020, ALEXANDRIA, VA, 22314, US

(73) Assignee: HITACHI-KOKUSAI ELECTRIC INC., Tokyo (JP)

(21) Appl. No.: 12/647,952

(22) Filed: Dec. 28, 2009

(30) Foreign Application Priority Data
Mar. 16, 2009 (JP) 2009-063161

(51) Int. Cl. F26B 25/08

(52) U.S. Cl. 34/194; 34/195; 34/218; 34/231; 34/236; 34/242

(57) ABSTRACT

Provided is a substrate processing apparatus that can decrease the time necessary for cooling a processed wafer for improving the throughput. The substrate processing apparatus comprises: a process chamber configured to process a substrate; a substrate supporter configured to support the substrate and load the substrate into the process chamber; a transfer mechanism configured to carry the substrate to the substrate supporter; and a non-sealing type shield part installed between the substrate supporter and the transfer mechanism.

### CROSS-REFERENCE TO RELATED PATENT APPLICATION

This U.S. non-provisional patent application claims priority under 35 U.S.C. §119 of Japanese Patent Application No. 2009-063161, filed on Mar. 16, 2009, in the Japanese Patent Office, the entire contents of which are hereby incorporated by reference.

### BACKGROUND OF THE INVENTION

1. Field of the Invention

The present invention relates to a substrate processing apparatus.

2. Description of the Prior Art

When a wafer, processed at high temperature in a wafer processing chamber, is directly unloaded to a transfer chamber, heat released from the wafer may cause troubles in the transfer chamber such as melting and breakdown of low thermal resistant parts and degassing of organic ingredients, and thus, problems such as stop of an apparatus or contamination of a wafer may arise. For this reason, in a conventional vertical semiconductor manufacturing apparatus, a processed wafer is left inside a wafer processing chamber until the processed wafer is cooled to a predetermined temperature, and then, the processed wafer is unloaded to a wafer transfer chamber. Since throughput is affected by the time during which wafers are left, action is taken to reduce such time, for example, a mechanism configured to discharge a large amount of air for taking heat from the entire region of the wafer processing chamber is installed, or inert gas is introduced into the inside of the wafer processing chamber.

However, it is not easy to take heat from a wafer having a small heat capacity by removing heat from the entire region of the wafer processing chamber having an overwhelmingly large heat capacity, and this method causes large facility loss and energy loss. In addition, due to a large flow of inert gas in the wafer processing chamber, film particles or product particles are scattered to reduce the yield.

In a semiconductor manufacturing apparatus disclosed in Patent Document 1 below, to enhance thermal shielding among a boat, wafers, and an elevator driving unit after a processing process, an arm supporting part of the elevator driving unit is configured to detour a thermal shield plate and extend horizontally, and the thermal shield plate is configured to vertically pass through the inside of the arm supporting part in a non-contact manner.

[Patent Document 1]

Japanese Unexamined Patent Application Publication No. 2005-285926

However, in the conventional art, time necessary for cooling wafers is long after the wafers are processed, and the throughput is decreased.

### SUMMARY OF THE INVENTION

An object of the present invention is to provide a substrate processing apparatus that can reduce the time necessary for cooling processed wafers so as to improve the throughput.

According to an aspect of the present invention, there is provided a substrate processing apparatus comprising: a process chamber processing a substrate; a substrate supporter supporting the substrate and loading the supported substrate into the process chamber; a transfer mechanism charging the substrate to the substrate supporter; and a non-sealing type shield part installed between the substrate supporter and the transfer mechanism. Thus, the time necessary for cooling processed wafers can be reduced.

### BRIEF DESCRIPTION OF THE DRAWINGS

FIG. 1 is a perspective view illustrating a substrate processing apparatus according to an embodiment of the present invention.

FIG. 2 is a side cross-sectional view illustrating the substrate processing apparatus according to an embodiment of the present invention.

FIG. 3 is a rear perspective view illustrating a thermal shield plate according to an embodiment of the present invention.

FIG. 4 is a front perspective view illustrating the thermal shield plate according to an embodiment of the present invention.

FIG. 5A and FIG. 5B illustrate the thermal shield plate according to an embodiment of the present invention, FIG. 5A being a plan view illustrating a state where the thermal shield plate is placed at a retraction position, FIG. 5B being a plan view illustrating a state where the thermal shield plate is placed at a cooling position.

FIG. 6A and FIG. 6B illustrate the thermal shield plate according to an embodiment of the present invention, FIG. 6A being a plan view illustrating a state where the thermal shield plate is placed at a retraction position, and FIG. 6B is a plan view illustrating a state where the thermal shield plate is placed at a cooling position.

### DETAILED DESCRIPTION OF THE PREFERRED EMBODIMENTS

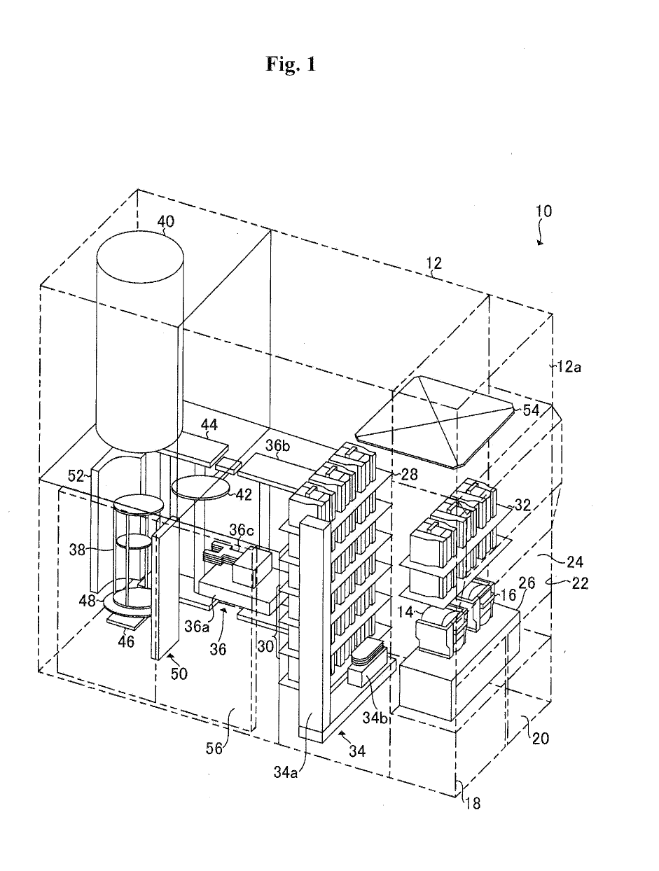

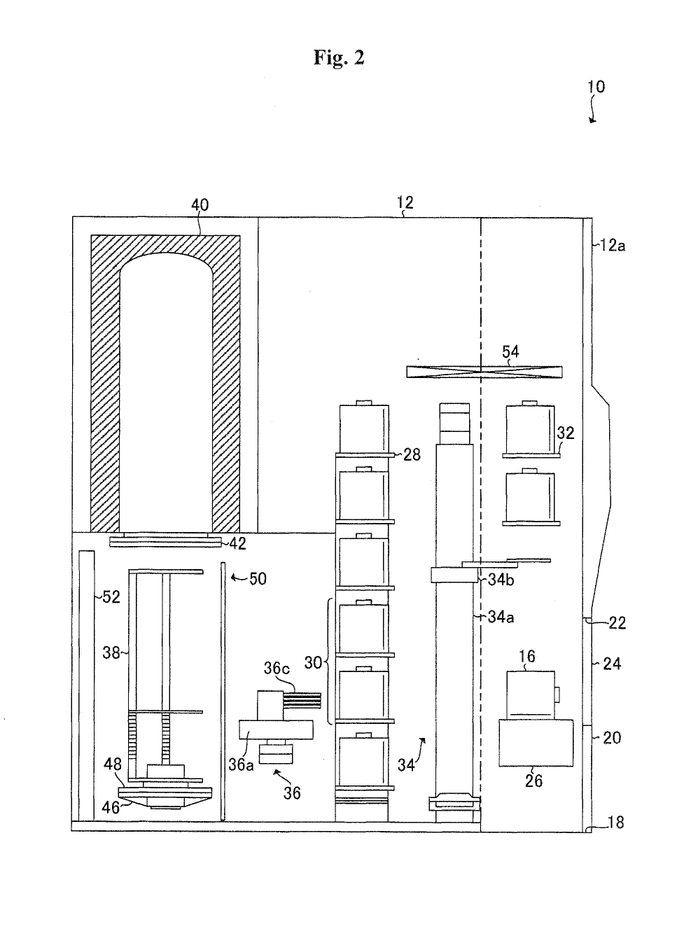

Preferable embodiments of the present invention will be described hereinafter with reference to the attached drawings. A substrate processing apparatus 10 according to an embodiment of the present invention is configured as, for example, a semiconductor manufacturing apparatus performing a process in a semiconductor device manufacturing method. FIG. 1 is a perspective view illustrating the substrate processing apparatus 10 according to an embodiment of the present invention. FIG. 2 is a side perspective view illustrating the substrate processing apparatus 10.

The substrate processing apparatus 10 is a batch type vertical semiconductor manufacturing apparatus, and includes a housing 12 in which main parts are disposed. In the substrate processing apparatus 10, for example, cassettes 16 accommodating substrates such as wafers 14 made of a material such as silicon are used as wafer carriers. At the lower side of a front wall 12a of the housing 12, a maintenance opening 18 is installed as an opening part for maintenance, and an openable maintenance door 20 is installed on the maintenance opening 18. At the maintenance door 20, a cassette loading opening 22 through which the cassettes 16 are loaded/unloaded is installed so that the inside and outside of the housing 12 can communicate with each other, and the cassette loading opening 22 is configured to be opened and closed by a front shutter 24. At the cassette loading opening 22 in the housing 12, a cassette stage 26 is installed.

The cassettes 16 are delivered between the cassette stage 26 and an in-process carrying device (not shown). The cassette 16 is placed on the cassette stage 26 by the in-process carrying device in a manner such that the wafers 14 are vertically positioned inside the cassette 16, and a wafer port of the cassette 16 faces upward. The cassette stage 26 is configured so that the cassette 16 can be vertically rotated by 90 degrees counterclockwise toward the rear side of the housing 12 for orienting the wafers 14 horizontally in the cassette 16 and pointing the wafer port of the cassette 16 toward the rear side of the housing 12.

Near the center part of the inside of the housing 12 in a front-rear direction, a cassette shelf 28 is installed. The cassette shelf 28 is configured such that the cassettes 16 can be stored in multiple rows and columns. At the cassette shelf 28, a transfer shelf 30 accommodating the cassettes 16 to be carried by a wafer transfer mechanism 36 (described later) is installed.

At the upper side of the cassette stage 26, a standby cassette shelf 32 is installed for storing the cassettes 16 preliminarily.

Between the cassette stage 26 and the cassette shelf 28, a cassette carrying device 34 is installed. The cassette carrying device 34 includes a cassette elevator 34a capable of moving upward and downward while holding a cassette 16, and a cassette carrying mechanism 34b configured to carry the cassette 110. By associated operations of the cassette elevator 34a and the cassette carrying mechanism 34b, the cassette carrying device 34 is configured to carry the cassette 16 among the cassette stage 26, the cassette shelf 28, and the standby cassette shelf 32.

At the rear side of the cassette shelf 28, the wafer transfer mechanism 36 is installed, and the wafer transfer mechanism 36 includes a wafer transfer device 36a capable of rotating or straightly moving a wafer 14 on a horizontal plane, and a wafer transfer device elevator 36b configured to move the wafer transfer device 36a upward and downward. The wafer transfer device elevator 36b is installed at the right end of the housing 12. By associated operations of the wafer transfer device 36a and the wafer transfer device elevator 36b, the wafer transfer mechanism 36 is configured to use tweezers 36c of the wafer transfer device 36a as stage parts on which the wafers 14 are placed, and to charge and discharge the wafers 14 into and from a boat 38 which functions as a substrate supporter configured to hold the wafers 14 horizontally in multiple rows.

At the rear upper side of the housing 12, a process furnace 40 is installed as a process chamber. The lower end of the process furnace 40 is configured to be opened and closed by a furnace port shutter 42. At the lower side of the process furnace 40, a boat elevator 44 is installed as an elevation mechanism configured to move the boat 38 upward into the process furnace 40 and downward from the process furnace 40. To an arm 46 connected to an elevator base of the boat elevator 44 as a connection tool, a seal cap 48 is horizontally fixed as a cover, and the seal cap 48 vertically supports the boat 38 to air-tightly seal the lower end of the process furnace 40.

The boat 38 includes a plurality of holding members and is configured to hold a plurality of wafers 14 (for example, about fifty to about one hundred fifty wafers) in a state where the wafers 14 are horizontally positioned and vertically arranged in multiple states with the centers of the wafers 14 being aligned.

Between the wafer transfer mechanism 36 and a lifting/lowering position of the boat 38, a thermal shield plate 50 functioning as a non-sealing type shield part is installed. When the wafers 14 are delivered between the wafer transfer device 36a and the boat 38, the thermal shield plate 50 is retracted to a position where the delivering of the wafers 14 is not interfered by the thermal shield plate 50. At a position of the rear side of the housing 12, an exhaust device 52 is installed to face the thermal shield plate 50.

At the upper side of the cassette shelf 28, a first cleaning unit 54, which includes a supply fan and a dust filter to supply clean air as clean atmosphere, is installed to circulate clean air throughout the housing 12.

At a left end of the housing 12 opposite to the wafer transfer device elevator 36b and the boat elevator 44, a second cleaning unit 56 including a supply fan and a dust filter to supply clean air is installed. Clean air discharged from the second cleaning unit 56 circulates around the wafer transfer device 36a and the boat 38, and then the clean air is sucked into the exhaust device 52 and is exhausted to the outside of the housing 12.

Next, the thermal shield plate 50 will now be described.

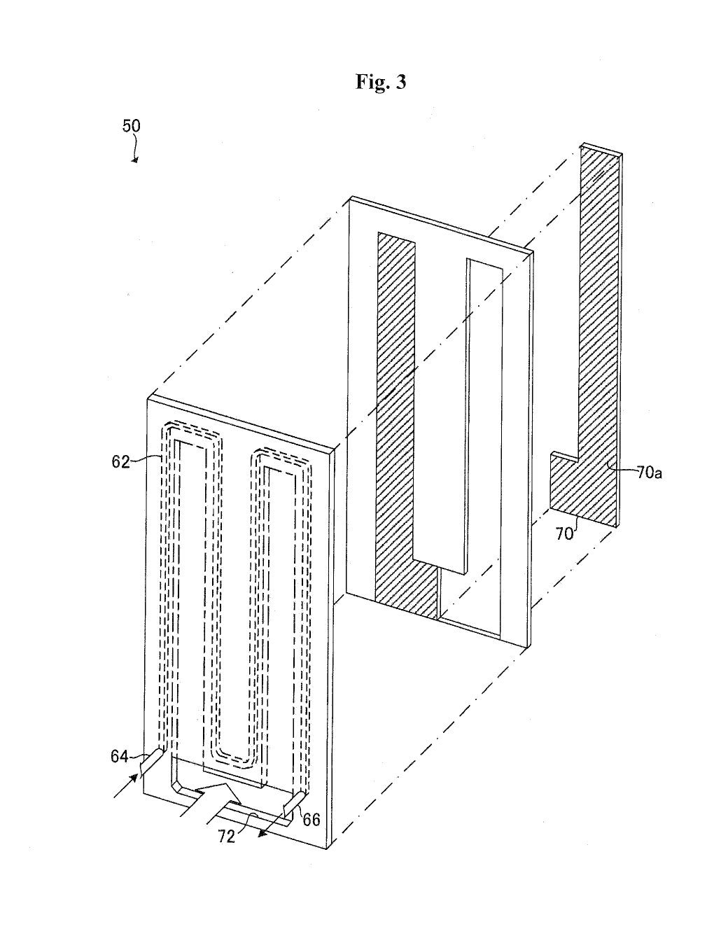

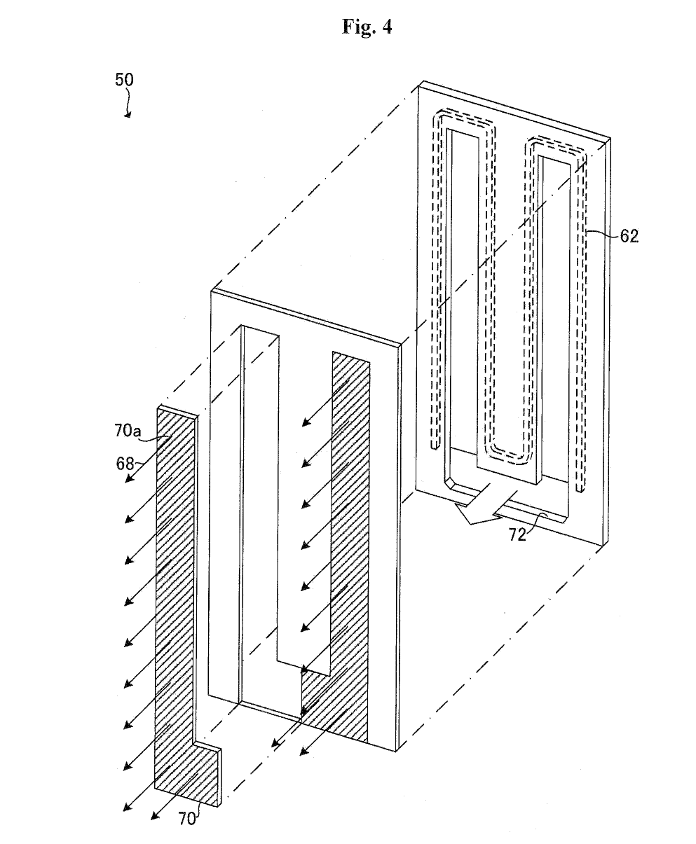

FIG. 3 and FIG. 4 illustrate a configuration of the thermal shield plate 50. FIG. 3 is a rear view illustrating the thermal shield plate 50, and FIG. 4 is a front view illustrating the thermal shield plate 50. The thermal shield plate 50 is made of, for example, aluminum alloy having high thermal conductivity and thermal resistance, and a surface of the thermal shield plate 50 may be processed with black alumite to increase heat absorptance.

The thermal shield plate 50 includes: a passage 62 through which coolant for cooling the thermal shield plate 50 flows; a coolant introducing opening 64 through coolant is introduced into the passage 62; a coolant discharging opening 66 through coolant is discharged after flowing through the passage 62; a cooling gas distributing part 70 through a clean cooling gas 68 is blown to the wafers 14 held by the boat 38; and a cooling gas introducing opening 72 through which the cooling gas 68 is guide to the thermal shield plate 50. In the cooling gas distributing part 70, distribution holes 70a are formed as distribution openings of the cooling gas 68.

For example, the passage 62 has a bonding structure of two pieces, which is formed by digging surfaces of the pieces to form a passage and bonding the pieces by welding.

For example, the cooling gas distributing part 70 may be made by using a punching panel, or a porous aluminum panel that also functions as a filter. In addition, the size and shape of the distribution holes 70a may be varied according to a desired flow rate of gas.

For example, when the wafers 14 held by the boat 38 are sequentially discharged from the lower end of the boat 38 and carried, so as to cool the wafer 14 held at the lower end of the boat 38 and carried ahead of the other wafers 14 more quickly than the wafer 14 held at the upper end of the boat 38, the size of a distribution hole 70a disposed at the lower side of the cooling gas distributing part 70 may be greater than the diameter of a distribution hole 70a disposed at the upper side of the cooling gas distributing part 70.

In addition, for example, to uniformly distribute the cooling gas 68 to the wafers 14 held by the boat 38, the diameter of the distribution holes 70a may be increased as it goes away from the cooling gas introducing opening 72.

The thermal shield plate 50 may be configured to gradually increase the flow rate of the cooling gas 68 distributed from the cooling gas distributing part 70 of the thermal shield plate 50, and to prevent the wafers 14 from being damaged by rapid cooling. In addition, the thermal shield plate 50 may be configured to gradually decrease the temperature of the cooling gas 68 distributed from the cooling gas distributing part 70 so as to prevent the wafers 14 from being damaged by rapid cooling.

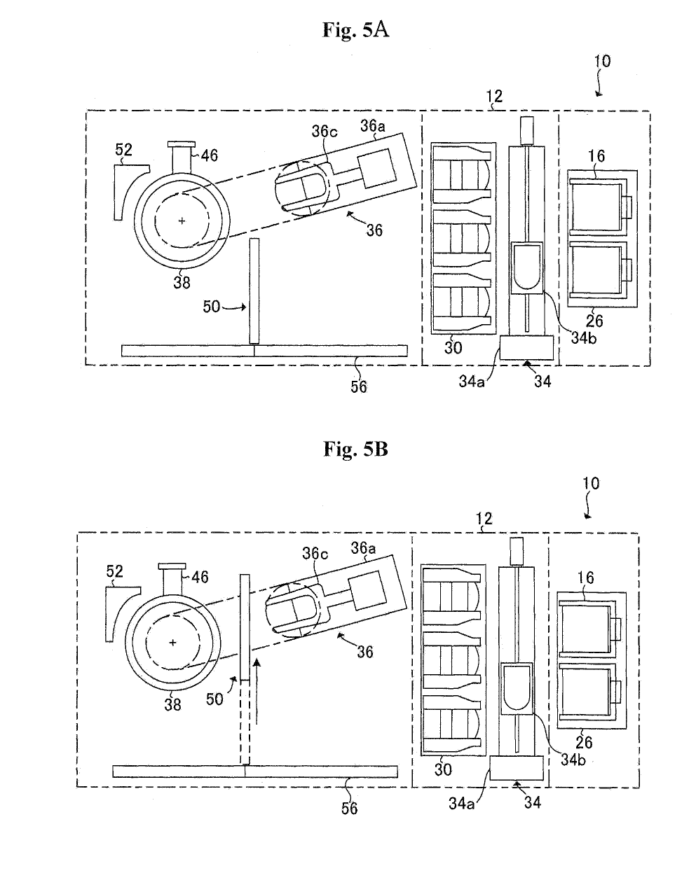

FIG. 5A and FIG. 5B are plan views illustrating a shifting operation of the thermal shield plate 50 in the substrate processing apparatus 10. FIG. 5A illustrates a state where the thermal shield plate 50 is placed at a retraction position, and FIG. 5B illustrates a state where the thermal shield plate 50 is placed at a cooling position. When the wafers 14 are delivered between the wafer transfer device 36a and the boat 38, the thermal shield plate 50 is retracted to a position (the retraction position) where the delivering of the wafers 14 is not interfered by the thermal shield plate 50. When the wafers 14 are cooled, the thermal shield plate 50 is moved to a position (the cooling position) between the wafer transfer device 36a and the boat 38 to absorb and shield heat released from the wafers 14.

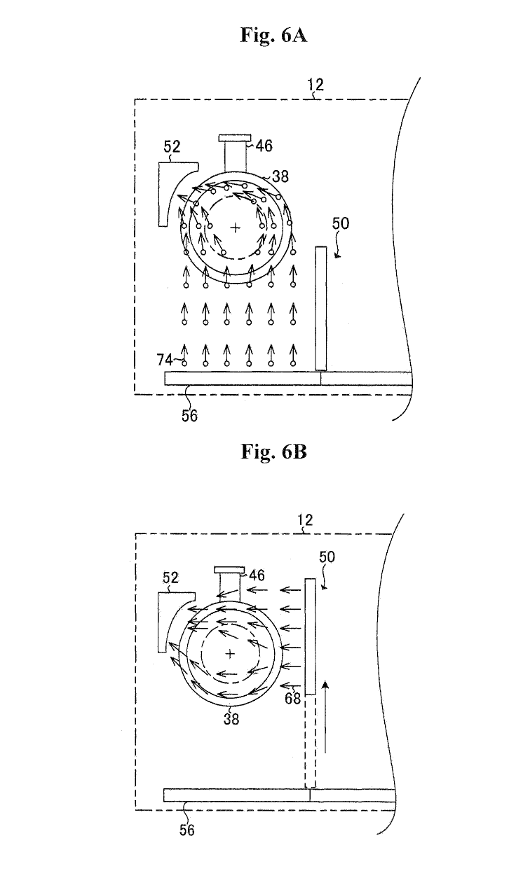

FIG. 6A and FIG. 6B are plan views illustrating the thermal shield plate 50, a flow of the cooling gas 68, and a peripheral structure of the thermal shield plate 50. FIG. 6A illustrates a state where the thermal shield plate 50 is placed at the retraction position, and FIG. 6B illustrates a state where the thermal shield plate 50 is placed at the cooling position.

When the thermal shield plate 50 is placed at the retraction position, clean air 74 distributed from the second cleaning unit 56 passes through the lifting/lowering position of the boat 38, and arrives at the exhaust device 52.

When the thermal shield plate 50 is placed at the cooling position, the cooling gas 68 distributed from the cooling gas distributing part 70 of the thermal shield plate 50 passes through the lifting/lowering position of the boat 38, and arrives at the exhaust device 52, together with the clean air 74 (not shown in FIG. 6B) distributed from the second cleaning unit 56. As such, since the thermal shield plate 50 distributes the cooling gas 68 at positions close to the wafers 14, a large amount of the cooling gas 68 can be supplied to the wafers 14 at a relatively high speed, and the wafers 14 can be rapidly cooled. In addition, since the thermal shield plate 50 is close to the wafers 14, the thermal shield plate 50 can absorb radiant heat from the wafers 14 for rapidly cooling the wafers 14.

Without being limited to the above description, the cooling gas 68 may be distributed from the cooling gas distributing part 70 all the time. In this case, the cooling gas distributing part 70 is prevented from being clogged by dust. In addition, at the thermal shield plate 50, a supply unit may be installed to distribute cooling gas 68 to the whole region of the boat 38 where the wafers 14 are placed. In this case, all the wafers 14 placed on the boat 38 can be simultaneously cooled.

The present invention is not limited to the above-described embodiments. For example, in a substrate processing apparatus in which a plurality of boats 38 are installed, a boat 38 may be carried to another processing apparatus instead of being carried to the lower side of a process furnace 40, and in this case, a thermal shield plate 50 may be installed at the place to which the boat 38 is carried.

In addition, the present invention is not limited to the above-described embodiment in which cooling gas 68 is distributed from the thermal shield plate 50. For example, instead of introducing cooling gas 68 from the cooling gas introducing opening 72, the cooling gas introducing opening 72 may be connected to an exhaust system to suck and exhaust high-temperature gas for cooling wafers 14 or other objects.

Next, an operation of the substrate processing apparatus 10 will be explained. Before the cassette 16 is supplied to the cassette stage 26, the cassette loading opening 22 is opened by the front shutter 24. Thereafter, the cassette 16 is loaded from the cassette loading opening 22, and is placed on the cassette stage 26 in the manner such that the wafers 14 are vertically positioned and the wafer port of the cassette 16 faces upward. The cassette 16 is vertically rotated by 90 degrees counterclockwise toward the rear side of the housing 12 by the cassette stage 26 so as to place the wafers 14 horizontally inside the cassette 16 and point the wafer port of the cassette 16 toward the rear side of the housing 12.

Then, the cassette 16 is automatically carried and placed by the cassette carrying device 34 from the cassette stage 26 to a predetermined position of the cassette shelf 28 or the standby cassette shelf 32, and is temporarily stored at the predetermined position. Thereafter, the cassette 16 is carried by the cassette carrying device 34 from the cassette shelf 28 or the standby cassette shelf 32 to the transfer shelf 30. Alternatively, the cassette 16 is directly carried from the cassette stage 26 to the transfer shelf 30 by the cassette carrying device 34.

When the cassette 16 is carried to the transfer shelf 30, the wafer 14 is picked up from the cassette 16 through the wafer port, and is charged to the boat 38 by the tweezers 36c of the wafer transfer device 36a. After the wafer transfer device 36a charges the wafer 14 to the boat 38, the wafer transfer device 36a returns to the cassette 16 disposed on the transfer shelf 30, and charges the next wafer 14 to the boat 38.

When a predetermined number of wafers 14 are charged to the boat 38, the lower end of the process furnace 40 closed by the furnace port shutter 42 is opened. Then, the seal cap 48 is raised by the boat elevator 44, and the boat 38 holding the wafers 14 is loaded into the process furnace 40. Thereafter, the wafers 14 are processed in the process furnace 40. After the processing of the wafers 14 is completed, the thermal shield plate 50 is moved to the cooling position, and then the boat 38 is unloaded from the process furnace 40 (boat down).

The boat 38 (the wafers 14) unloaded from the process furnace 40 is cooled by the thermal shield plate 50. When the wafers 14 are cooled to a predetermined temperature, the thermal shield plate 50 is moved to the retraction position. Thereafter, in the reverse order to the above-described operation, the wafers 14 are carried from the boat 38 to the cassette 16 of the transfer shelf 30. The cassette 16 is carried from the transfer shelf 30 to the cassette stage 26 by the cassette carrying mechanism 34b, and is unloaded to the outside of the housing 12 by the in-process carrying device (not shown).

As described above, the present invention provides a substrate processing apparatus capable of decreasing the time necessary for cooling a processed wafer for improving the throughput.

(Supplementary Note)

The present invention also includes the following embodiments.

(Supplementary Note 1)

According to a preferred embodiment of the present invention, there is provided a substrate processing apparatus comprising: a process chamber configured to process a substrate; a substrate supporter configured to support the substrate and load the substrate into the process chamber; a transfer mechanism configured to carry the substrate to the substrate supporter; and a non-sealing type shield part installed between the substrate supporter and the transfer mechanism.

(Supplementary Note 2)

In the substrate processing apparatus of Supplementary Note 1, the shield part may comprise a distribution part configured to distribute clean gas.

(Supplementary Note 3)

In the substrate processing apparatus of Supplementary Note 2, the shield part may be movable between a cooling position at which the substrate supported by the substrate supporter is cooled and a retraction position located away from the cooling position;

the shield part may be moved to the cooling position before the substrate loaded into the process chamber by the substrate supporter is unloaded from the process chamber; and

a flow rate of clean air distributed through the distribution part of the shield part when the shield part is placed at the cooling position may be greater than a flowrate of clean air distributed through the distribution part when the shield part is placed at the retraction position.

What is claimed is:

1. A substrate processing apparatus comprising:
a process chamber configured to process a substrate;
a substrate supporter configured to support the substrate and load the substrate into the process chamber;
a transfer mechanism configured to carry the substrate to the substrate supporter; and
a non-sealing type shield part installed between the substrate supporter and the transfer mechanism.

2. The substrate processing apparatus of claim 1, wherein the shield part comprises a distribution part configured to distribute clean gas.

3. The substrate processing apparatus of claim 2, wherein the shield part is movable between a cooling position at which the substrate supported by the substrate supporter is cooled and a retraction position located away from the cooling position,
the shield part is moved to the cooling position before the substrate loaded into the process chamber by the substrate supporter is unloaded from the process chamber, and
a flow rate of clean air distributed through the distribution part of the shield part when the shield part is placed at the cooling position is greater than a flowrate of clean air distributed through the distribution part when the shield part is placed at the retraction position.
